(19) United States
(12) Patent Application Publication
(10) Pub. No.: US 2003/0173756 A1
(43) Pub. Date: Sep. 18, 2003

(54) Steering assist apparatus, a vehicle using the steering assist apparatus and a method for steering

(76) Inventor: Raymond Mullins, Clifton, IL (US)

Correspondence Address: PATENTS+TMS, A Professional Corporation, 1914 North Milwaukee Avenue, Chicago, IL, 60647, US

(21) Appl. No.: 10/097,915

(22) Filed: Mar. 13, 2002

(51) Int. Cl. B62K 21/00; B62K 11/14; B62K 19/30

(52) U.S. Cl. 280/265; 180/219; 280/291

(57) ABSTRACT

A steering assist apparatus, a vehicle using the steering assist apparatus and a method for steering are provided. The steering assist apparatus assists a rider with steering a vehicle, such as a motorcycle or trike. The feet and/or legs of the rider are used as an assist to effect movement of handlebars normally controlled only by the hands and/or arms of the rider. The steering assist apparatus may reduce the amount of work required to steer the vehicle.

### BACKGROUND OF THE INVENTION

The present invention generally relates to a steering assist apparatus, a vehicle using the steering assist apparatus and a method for steering. More specifically, the apparatus relates to a steering assist apparatus that assists the steering mechanism of a vehicle, such as a motorcycle or trike, through use of feet and/or legs by a user or rider of the vehicle.

Steering of a vehicle such as, for example, a motorcycle or a trike, by a user, such as a rider of the vehicle, is often laborious. A trike may be a vehicle similar to a motorcycle. Generally, a trike may have three wheels and may be more stable than a motorcycle. In another embodiment, a trike may be a motorcycle with two wheels having a trike conversion kit attached. The trike conversion kit may have two rear wheels that are located outside of the existing rear wheel of the motorcycle. A vehicle using the trike conversion kit has four total wheels on the vehicle; one wheel in front and three wheels in the rear.

Extended riding often fatigues the rider due to the amount of work necessary to steer the vehicle. The traditional method for steering the vehicle involves the rider using his/her hands to push and pull one or more handlebars. After pushing and/or pulling the handlebars, which connect to a linkage to effectively turn the vehicle, the vehicle turns in the direction that the handlebars are pushed and/or pulled by the rider.

Turning the vehicle is laborious because the rider is inherently pulling the handlebars against the forward thrust of the vehicle as well as against the centripetal force of the vehicle. Currently, the rider only uses his/her hands and/or arms to turn the handlebars of the vehicle, as well as any pressure and/or bodyweight that the rider exerts on the handlebars via his/her hands and/or arms. Therefore, the rider becomes quickly fatigued; the hands and/or the arms are not capable of performing the amount of work necessary to steer and guide the vehicle over long trips or trips requiring a large amount of steering and/or turns.

If the rider drives the vehicle for an extended period, the rider may become fatigued or weakened. A fatigued rider may be dangerous to other vehicles around the rider or any other obstacle that the vehicle encounters. Fatigued riding is also dangerous to the rider. The danger arises since the rider can not adequately control the vehicle when fatigued.

A need, therefore, exists for an improved steering assist apparatus that reduces the amount of work required to steer a vehicle, such as, for example, a motorcycle or a trike. A further need exists for a vehicle using the steering assist apparatus as well as a method for steering the vehicle.

### SUMMARY OF THE INVENTION

The present invention generally relates to a steering assist apparatus, a vehicle using the steering assist apparatus and a method for steering. More specifically, the apparatus relates to a steering assist apparatus that assists the steering mechanism of a vehicle, such as a motorcycle or trike, through use of the feet and/or legs of a user or rider of the vehicle.

To this end, in an embodiment of the present invention, a steering assist apparatus is provided. The apparatus has a first arm having a first end and a second end wherein the first arm attaches to the vehicle. The apparatus further has a second arm having a first end and a second end wherein the second arm pivotally connects to the first arm. The apparatus also has a third arm attached to the steering mechanism and a linkage rod attached to the third arm and the second arm.

In an embodiment, the apparatus has a first fastener securing the first end of the first arm to the vehicle.

In an embodiment, the apparatus has a second fastener securing the second end of the first arm to the vehicle.

In an embodiment, the apparatus has a bearing between the first arm and the second arm enabling the second arm to pivot.

In an embodiment, the apparatus has a lock attached to the first arm and the second arm preventing disconnection between the first arm and the second arm.

In an embodiment, the apparatus has a first fastener connecting the linkage rod to the second arm.

In an embodiment, the apparatus has a second fastener connecting the linkage rod to the third arm.

In another embodiment of the present invention, a vehicle having at least two wheels wherein the vehicle is driven by a rider having feet is provided. The vehicle has an undercarriage and a steering mechanism to control direction of the wheels. The vehicle further has an arm attached to the steering mechanism and a base connected to the undercarriage and the arm wherein the feet of the rider move the base to alter the direction of the wheels.

In an embodiment, the vehicle has a bracket pivotally attached to the base.

In an embodiment, the vehicle has a connector attaching the base to the arm.

In an embodiment, the vehicle has a connector attaching the arm to the steering mechanism.

In an embodiment, the vehicle has a brace attached to the arm.

In an embodiment, the vehicle has a beam attached to the arm.

In an embodiment, the vehicle has a foot peg attached to the bracket.

In another embodiment of the present invention, a method for steering a vehicle driven by a rider, wherein the vehicle has at least two wheels and handlebars, a direction of movement of the wheels and the vehicle controlled by a hand or a foot of the rider is provided. The method has the steps of: attaching a steering assist apparatus to the vehicle and controlling the steering assist apparatus with only the foot of the rider.

In an embodiment, the method has the step of moving the handlebars with the hands of the rider during control of the steering assist apparatus with the foot of the rider.

In an embodiment, the method has the step of securing a linkage between the steering assist apparatus and the foot of the rider.

In an embodiment, the method has the step of securing a first arm and a second arm to the steering apparatus to extend on opposite sides of the vehicle.

In an embodiment, the method has the step of securing the steering assist apparatus to the vehicle without disassembly of any parts of the vehicle.

In an embodiment, the method has the step of attaching foot pedals to the steering assist apparatus.

It is, therefore, an advantage of the present invention to provide a steering assist apparatus, a vehicle using the steering assist apparatus and a method for steering that reduces the amount of work required to steer a vehicle.

Another advantage of the present invention is to provide a steering assist apparatus, a vehicle using the steering assist apparatus and a method for steering that employs a rider's feet for steering the vehicle.

Yet another advantage of the present invention is to provide a steering assist apparatus, a vehicle using the steering assist apparatus and a method for steering that connects to an existing undercarriage of the vehicle.

Another advantage of the present invention is to provide a steering assist apparatus, a vehicle using the steering assist apparatus and a method for steering that provides the rider with an area to rest their feet.

Moreover, an advantage of the present invention is to provide a steering assist apparatus, a vehicle using the steering assist apparatus and a method for steering that installs onto a vehicle easily and quickly.

A further advantage of the present invention is to provide a steering assist apparatus, a vehicle using the steering assist apparatus and a method for steering that bolts to the undercarriage of the vehicle.

Another advantage of the present invention is to provide a steering assist apparatus, a vehicle using the steering assist apparatus and a method for steering that assists the rider in steering the vehicle.

Yet another advantage of the present invention is to provide a steering assist apparatus, a vehicle using the steering assist apparatus and a method for steering that is inexpensive to manufacture.

A still further advantage of the present invention is to provide a steering assist apparatus, a vehicle using the steering assist apparatus and a method for steering that may allow the rider to use only his/her hands or only his/her feet to steer the vehicle.

Moreover, additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of an embodiment of the present invention showing the steering assist apparatus attached to a vehicle.

FIG. 2 illustrates an exploded perspective view of an embodiment of the present invention showing the steering assist apparatus.

FIG. 3 illustrates an exploded perspective view of an embodiment of the present invention showing a pivot point of the steering assist apparatus.

### DETAILED DESCRIPTION OF THE PRESENTLY PREFERRED EMBODIMENTS

The present invention generally relates to a steering assist apparatus, a vehicle using the steering assist apparatus and a method for steering. More specifically, the apparatus relates to a steering assist apparatus that assists the steering mechanism of a vehicle, such as a motorcycle or trike, through use of the feet and/or legs.

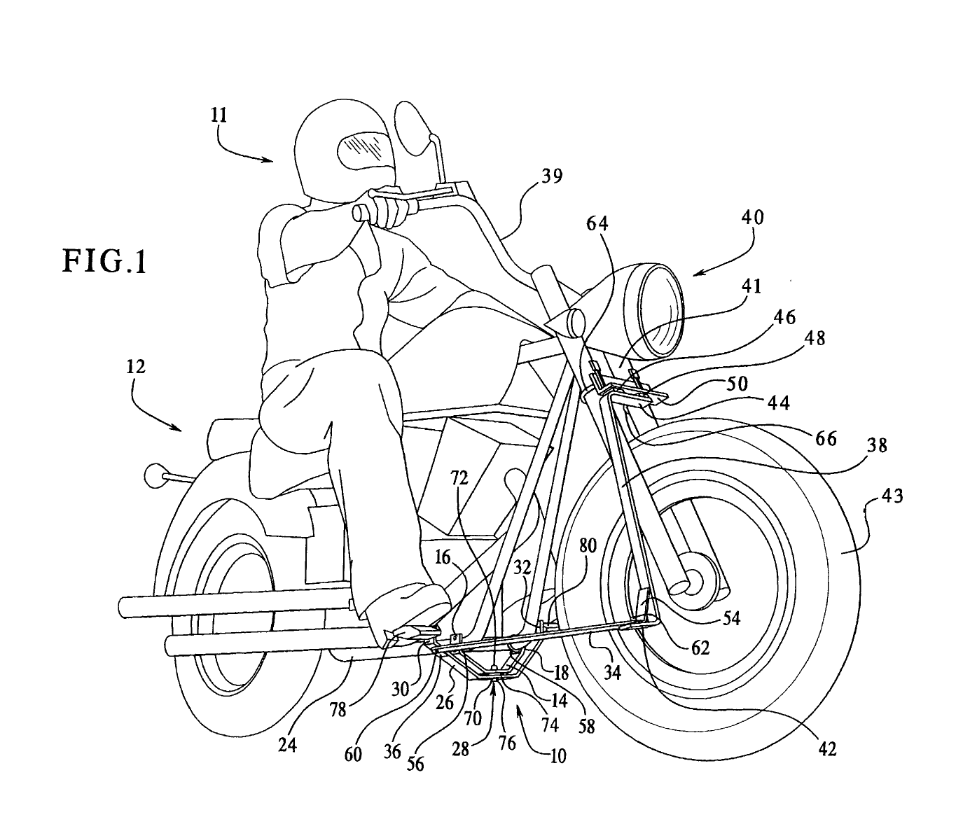

Referring now to the drawings, wherein like numerals refer to like parts, FIG. 1 illustrates an embodiment of the present invention showing a steering assist apparatus 10 and a vehicle 12. The vehicle 12 may be, for example, a motorcycle or a trike. However, it should be understood that any vehicle implementing “handlebar steering” may implement the steering assist apparatus 10 of the present invention.

“Handlebar steering” may refer to the commonly known type of steering generally used to control a vehicle utilizing one or more handlebars 39 as part of a steering mechanism 40. The steering mechanism 40 may include one or more handlebars 39 attached to one or more front forks 41. The front forks 41 may be connected to a front wheel 43. Therefore, the front wheel 43 may turn as a rider 11 pushes and/or pulls the handlebars 39.

The steering assist apparatus 10 may have a first arm 14 having a first end 16 and a second end 18. The first end 16 and the second end 18 may be fastened to the first arm 14 to the vehicle 12 using a first fastener 56 and a second fastener 58, respectively. The first end 16 and the second end 18 may fasten to an undercarriage 24 of the vehicle 12. The first fastener 56 and the second fastener 58 of the first arm 14 may be any one of a plurality of different types of fasteners, such as, for example, u-bolts or standard bolts. U-bolts or standard bolts, for example, may be used so that installation of the steering assist apparatus 10 may be accomplished by screwing various nuts onto various threaded bolt ends.

The steering assist apparatus 10 may be secured to the vehicle 12 so that the rider 11 may operate the steering assist apparatus 10 while using the steering mechanism 40. Securing the first arm 14 to the vehicle 12 may anchor the steering assist apparatus 10. Preferably, disconnection of the steering assist apparatus 10 may not occur during operation of the vehicle 12. The steering assist apparatus 10 may be disconnected from the vehicle 12 by unfastening the first fastener 56 and the second fastener 58.

The first arm 14 may have a plurality of braces to reinforce and/or support the first arm 14. In an embodiment, a first brace 20 and a second brace 22 may be provided. The first brace 20 and the second brace 22 of the first arm 14 may be attached to the top of the first arm 14.

The first arm 14 may attach to a second arm 26 at a pivot point 28. The second arm 26 may have a first point 30 and a second point 32. The second arm 26 may pivot beneath the first arm 14 when the rider 11 manipulates the first point 30 and the second point 32 using their feet and/or legs. The rider 11 may manipulate the first point 30 and the second point 32 by pushing his/her feet on the first point 30 or the second point 32. Pushing the first point 30 or the second point 32 assists the turning of the steering mechanism 40. In use, the rider 11 may push the first point 30 or the second point 32 while turning the steering mechanism to assist the steering of the vehicle 12.

The second arm 26 may be attached to a linkage rod 34. The linkage rod 34 may be attached to an extension 36 on the second arm 26. The extension 36 may be located near the second point 32. The linkage rod 34 may provide a connection from the first arm 14 and the second arm 26 to a third arm 38 of the steering assist apparatus 10. The linkage rod 34 may have a first connector 60 that may connect the linkage rod 34 to the extension 36 on the second arm 26. The first connector 60 may be any one of a plurality of different types of connectors. In an embodiment, a ball connector may be used. A ball connector may be used so that rotary motion may be established for the linkage rod 34 at the first connector 60.

The third arm 38 may have a first apex 42 and a second apex 44. The third arm 38 may connect the linkage rod 34 to the steering mechanism 40 of the vehicle 12. The third arm 38 may connect to the linkage rod 34 at the first apex 42. The linkage rod 34 may have a second connector 62 that may connect the linkage rod 34 to the first apex 42 on the third arm 38. The second connector 62 may be a plurality of different types of connectors. In an embodiment, a ball connector may be used. The ball connector may be used so that rotary motion may be established for the linkage rod 34 at the first apex 42.

Further, the third arm 38 may attach to the steering mechanism 40 near the second apex 44. The third arm 38 may have a plurality of projections near the second apex 44. In an embodiment, a first projection 46 and a second projection 48 are provided. The first projection 46 and the second projection 48 on the third arm 38 may provide a connection to the cross member 50. The cross member 50 may connect the third arm 38 to the steering mechanism 40 using a first fastener 64 and a second fastener 66. The first fastener 64 and the second fastener 66 may be, for example, u-bolts or standard bolts.

The third arm 38 may have a plurality of braces to reinforce and/or support the third arm 38. In an embodiment, a first brace 52 may be attached to the third arm 38. The third arm 38 may further have a support beam 54 for reinforcing and supporting the third arm 38. In an embodiment, the support beam 54 may be attached to the first apex 42 and the third arm 38.

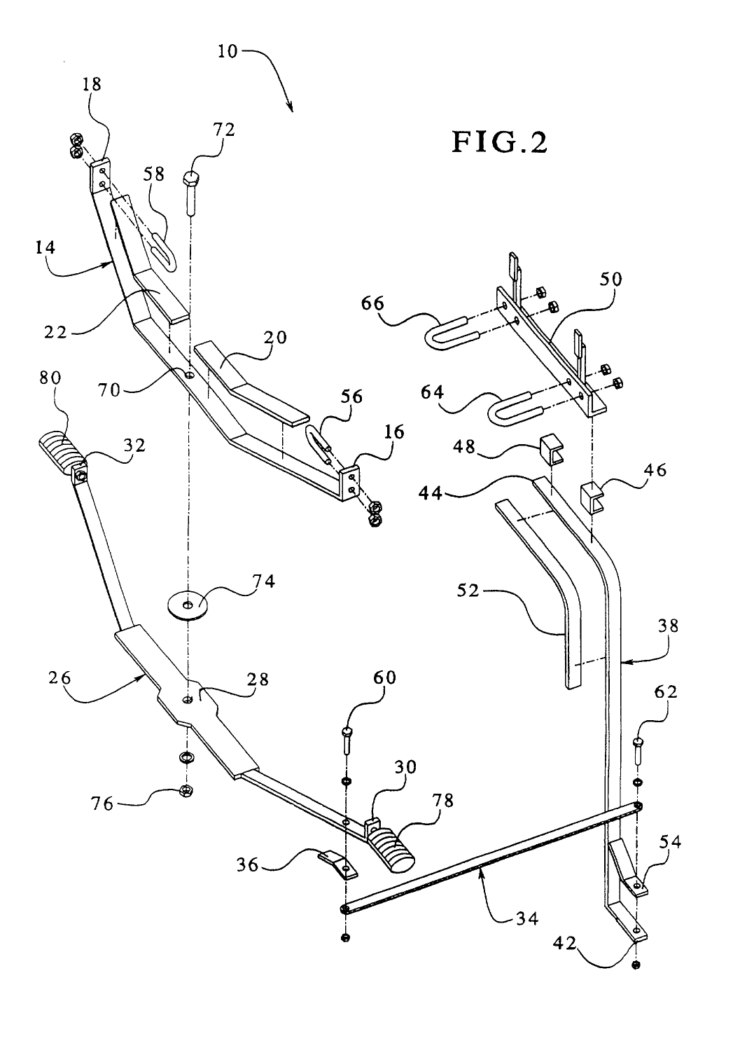

Referring now to FIG. 2, the first arm 14 may have the pivot point 28 with an aperture 70. A bolt 72 may be placed through the aperture 70 so that the first arm 14 and the second arm 16 may be secured together. A bushing 74 may be located at the pivot point 68 between the first arm 14 and the second arm 26. The bushing 74 may facilitate the pivoting of the second arm 26 when the second arm 26 is attached to the first arm 14. In the alternative, a ball bearing may be used in place of the bushing 74 between the first arm 14 and the second arm 26. A nut 76 may secure to the bolt 72 and fasten the first arm 14 to the second arm 26.

FIG. 2 further illustrates a first footpeg 78 and a second footpeg 80. The first footpeg 78 and the second footpeg 80 may attach to the first point 30 and the second point 32, respectively, of the second arm 26. The rider 11 may manipulate the steering assist apparatus 10 using his/her feet and/or legs to push the first footpeg 78 and/or the second footpeg 80. When the rider 11 pushes the first footpeg 78, the steering assist apparatus 10 may turn the vehicle 12 in a direction. Likewise, when the rider 11 pushes the second footpeg 80, the steering assist apparatus 10 may turn the vehicle 12 in an opposite direction.

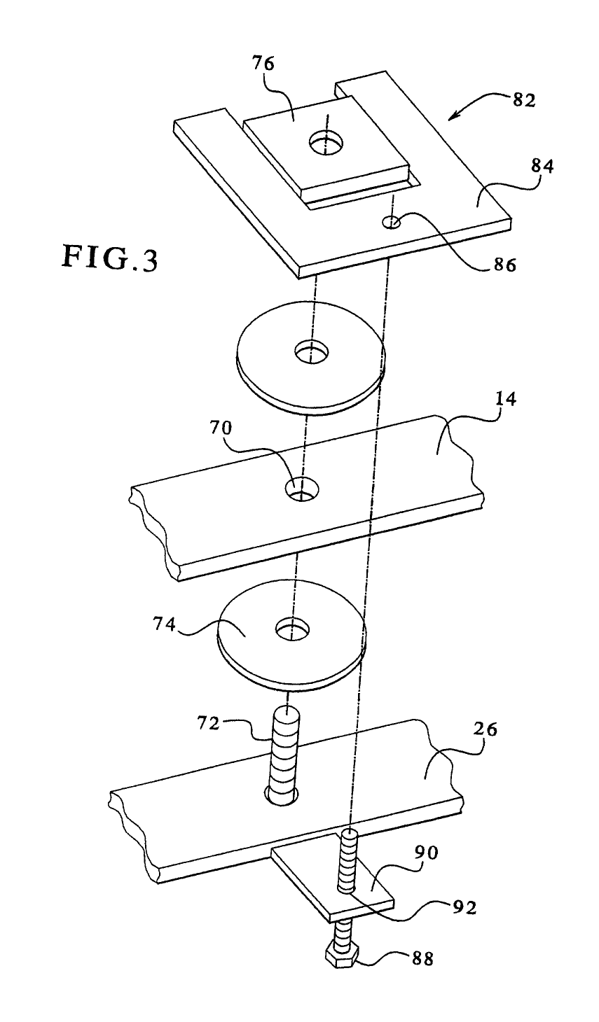

Referring now to FIG. 3, in an embodiment, a nut lock 82 may surround the nut 76 and be attached to an extension 90 on the second arm 26 so that the first arm 14 and the second arm 26 may not disconnect. The nut lock 82 may be three pieces, namely, a U-shaped piece 84 with a bore 86, an extension 90 on the second arm 26 and a bolt 88. Preferably, the extension 90 is integrally formed with the second arm 26; however, the extension 90 may be separately secured to the second arm 26. The U-shaped piece 84 may surround the nut 76. The extension 90 may have a bore 92 through which the bolt 88 may secure to the U-shaped piece 84 of the nut lock 82 to the second arm 26.

The bolt 88 and the nut 76 may secure the U-shaped piece 84 to the second arm 26 by securing the bolt 88 through the bore 86 of the U-shaped piece 84 and the bore 92 of the extension 90 and then attaching the nut 76 to the bolt 88. The U-shaped piece 84 may surround the nut 76 to prevent the first arm 14 and the second arm 26 from loosening and/or disconnecting.

The steering assist apparatus 10 may be fastened to the vehicle 12 when the rider 11 desires assisted steering for the vehicle 12. The steering assist apparatus 10 may be disconnected from the vehicle 12 when the rider 11 does not desire assisted steering provided by the steering assist apparatus 10. The steering assist apparatus 10 may be disconnected by un-fastening the first fastener 56 and the second fastener 58 which are used to connect the steering assist apparatus 10 to the vehicle 12.

The steering assist apparatus 10 may assist the steering mechanism 40 to steer the vehicle 12. The assistance provided by the steering assist apparatus 10 may reduce the amount of work required to steer the vehicle 12. The rider 11 may use his/her feet and/or legs to steer the vehicle 12 while using the “handlebar steering”, as previously defined, of the steering mechanism 40.

In use, the rider 11 may push and/or pull the handlebars 39 of the steering mechanism 40 with his/her hands and/or arms while using her/her feet and/or legs to push the first footpeg 78 or the second footpeg 80 of the steering assist apparatus 10. Alternatively, the rider 11 may use only the steering mechanism 40 or only the steering assist apparatus 10 to steer the vehicle 12.

Pushing the first footpeg 78 or the second footpeg 80 may pivot the second arm 26. Pivoting the second arm 26 may move the linkage rod 34 toward the front of the vehicle 12 or toward the rear of the vehicle 12. Moving the linkage rod 34 may turn the third arm 38. Since the third arm 38 may be attached to the handlebars 39, the handlebars 39 may turn as the linkage rod 34 is moved. Therefore, when the rider 11 pushes the first footpeg 78 or the second footpeg 80, the handlebars 39 may turn in a direction corresponding to the footpeg pushed by the rider 11. For example, if the rider 11 pushes the first footpeg 78, the handlebars 39 may turn in a direction towards the right causing the vehicle 12 to turn to the same direction. Further, for example, if the rider 11 pushes the second footpeg 80, the handlebars 39 may turn in a direction towards the left causing the vehicle 12 to turn to the same direction.

It should be understood that various changes and modifications to the presently preferred embodiments described herein will be apparent to those skilled in the art. Such changes and modifications may be made without departing from the spirit and scope of the present invention and without diminishing its attendant advantages. It is therefore intended that such changes and modifications be covered by the appended claims.

I claim:

1. A steering assist apparatus for assisting a steering mechanism of a vehicle, the apparatus comprising:
a first arm having a first end and a second end wherein the first arm attaches to the vehicle;
a second arm having a first end and a second end wherein the second arm pivotally connects to the first arm;
a third arm attached to the steering mechanism; and
a linkage rod attached to the third arm and the second arm.

2. The steering assist apparatus of claim 1 further comprising:
a first fastener securing the first end of the first arm to the vehicle.

3. The steering assist apparatus of claim 1 further comprising:
a second fastener securing the second end of the first arm to the vehicle.

4. The steering assist apparatus of claim 1 further comprising:
a bearing between the first arm and the second arm enabling the second arm to pivot.

5. The steering assist apparatus of claim 1 further comprising:
a lock attached to the first arm and the second arm preventing disconnection between the first arm and the second arm.

6. The steering assist apparatus of claim 1 further comprising:
a first fastener connecting the linkage rod to the second arm.

7. The steering assist apparatus of claim 1 further comprising:
a second fastener connecting the linkage rod to the third arm.

8. A vehicle having at least two wheels wherein the vehicle is driven by a rider having feet, the vehicle comprising:
an undercarriage;
a steering mechanism to control direction of the wheels;
an arm attached to the steering mechanism; and
a base connected to the undercarriage and the arm wherein the feet of the rider move the base to alter the direction of the wheels.

9. The vehicle of claim 8 further comprising:
a bracket pivotally attached to the base.

10. The vehicle of claim 8 further comprising:
a connector attaching the base to the arm.

11. The vehicle of claim 8 further comprising:
a connector attaching the arm to the steering mechanism.

12. The vehicle of claim 8 further comprising:
a brace attached to the arm.

13. The vehicle of claim 8 further comprising:
a beam attached to the arm.

14. The vehicle of claim 9 further comprising:
a foot peg attached to the bracket.

15. A method for steering a vehicle driven by a rider, wherein the vehicle has at least two wheels and handlebars, a direction of movement of the wheels and the vehicle controlled by a hand or a foot of the rider, the method comprising the steps of:
attaching a steering assist apparatus to the vehicle;
controlling the steering assist apparatus with only the foot of the rider.

16. The method of claim 15 further comprising the step of:
moving the handlebars with the hands of the rider during control of the steering assist apparatus with the foot of the rider.

17. The method of claim 15 further comprising the step of:
securing a linkage between the steering assist apparatus and the foot of the rider.

18. The method of claim 15 further comprising the step of:
securing a first arm and a second arm to the steering apparatus to extend on opposite sides of the vehicle.

19. The method of claim 15 further comprising the step of:
securing the steering assist apparatus to the vehicle without disassembly of any parts of the vehicle.

20. The method of claim 15 further comprising the step of:
attaching foot pedals to the steering assist apparatus.
